(19) United States
(12) Patent Application Publication
(10) Pub. No.: US 2016/0179368 A1
(43) Pub. Date: Jun. 23, 2016

(54) INTELLIGENT SMALL SCREEN LAYOUT AND POP-UP KEYPADS FOR SCREEN-ONLY DEVICES

(71) Applicant: Hand Held Products, Inc., Fort Mill, SC (US)

(72) Inventor: William Roeder, John's Creek, GA (US)

(21) Appl. No.: 14/943,122

(22) Filed: Nov. 17, 2015

Related U.S. Application Data
(60) Provisional application No. 62/094,442, filed on Dec. 19, 2014.

(51) Int. Cl. G06F 3/0488; H04L 29/08

(52) U.S. Cl. CPC G06F 3/04886; H04L 67/02

(57) ABSTRACT

A method of controlling the formatting of a screen of an electronic device in communication with a host computer includes establishing an electronic communication between a remote client on an electronic device and a host computer; capturing a plurality of host display screens from a host computer; assigning each captured host display screen an identification code; defining a small screen device layout to match each captured host display screen, wherein the device layout is sized for the screen of the electronic device; loading the small screen device layout on the small screen of the electronic device; and loading a predefined keypad sized for the small screen of the electronic device. When the electronic device establishes a subsequent electronic communication with the host computer, the appropriate small screen device layout is displayed instead of the corresponding host display screen from the host computer by detecting the identification code assigned thereto.

### CROSS-REFERENCE TO RELATED APPLICATION

The present application claims the benefit of U.S. Patent Application No. 62/094,442 for an Intelligent Small Screen Layout and Pop-Up Keypads for Screen-Only Devices filed on Dec. 19, 2014, which is hereby incorporated by reference in its entirety.

### FIELD OF THE INVENTION

The invention is generally related to software keypads for electronic devices having touch panels, and, more specifically, to intelligent small screen layout and pop-up keypads for screen-only devices.

### BACKGROUND

Historically, portable data collection devices have included true, physical keypads for data entry. Newer portable data collection devices include touch screens that lack physical keypads. Users who want to do manual data entry rely on software-based popup keypads to substitute for the traditional true keypad. Both the touch screens and the keypads are small and can be difficult to use.

If a software application has been written to run locally on the device, it can automatically popup the keypads as appropriate. However, if the device is running a terminal emulator or a browser, rather than a specific local application, the device does not have local control of the keypads. These implementations rely on the user to manually call up keypad overlays as needed. Furthermore, the display screens from the host computer are not usually appropriately sized for the small touch screen. The combination of the improperly sized host computer screens, generally formatted for large screens with true keypad input, and manually called pop-up keypads without proper context, leaves the user with a sub-optimal, at best, or unusable, at worst, electronic device experience. Existing application programs running on an electronic device would be more user-friendly if they were able to automatically call an appropriate small screen layout with appropriately sized pop-up keypad.

### SUMMARY

In one aspect of the invention, a method of controlling the formatting of a screen of an electronic device in communication with a host computer in a networked computer environment, comprising the steps of establishing an electronic communication between a remote client on an electronic device and a host computer; capturing a plurality of host display screens from a host computer; assigning each captured host display screen an identification code; defining a small screen device layout to match each captured host display screen, wherein the device layout is sized for the screen of the electronic device; loading the small screen device layout on the small screen of the electronic device; and loading a predefined keypad sized for the small screen of the electronic device; whereby when the electronic device establishes a subsequent electronic communication with the host computer, the appropriate small screen device layout is displayed instead of the corresponding host display screen from the host computer by detecting the identification code assigned thereto.

In an embodiment, the electronic device is a portable data terminal.

In another embodiment, the remote client is terminal emulation software.

In another embodiment, the electronic communication is established through Telnet protocol.

In yet another embodiment, the remote client is web browsing software.

In an embodiment, the electronic communication is established through hypertext transfer protocol.

In an embodiment, the small screen is a small touch screen.

In another embodiment, the predefined keypad is stored on a memory in the electronic device or in a memory in the host computer.

In another embodiment, the set of keys of the predefined keypad includes numeric keys only.

In another embodiment, the set of keys of the predefined keyboard includes all alphanumeric keys.

In yet another embodiment, the set of keys of the predefined keyboard includes function keys.

In another aspect of the invention, a method of controlling a soft keypad in a networked computer environment, comprising the steps of providing a host computer having a host computer program with a plurality of host display screens; providing an electronic device having a small screen, a plurality of small screen device layouts each corresponding to the plurality of host display screens of the host computer program stored in a memory of the electronic device, a plurality of identification codes assigned to the plurality of host display screens from the host computer program stored in a memory of the electronic device, and a remote client for communicating with said host computer; establishing an electronic communication between said remote client on said electronic device and said host computer, the electronic communication requiring keypad input; receiving one of the plurality of host display screens from a host computer program; detecting the identification code assigned to the received host display screen of the host computer program; displaying one of the plurality of stored small screen device layouts corresponding to the received host display screen based on the identification code instead of the received host display screen from the host computer program; and displaying a predefined keypad sized on the small screen that corresponds to the detected identification code.

In an embodiment, the electronic device is a portable data terminal.

In an embodiment, the remote client is terminal emulation software.

In another embodiment, the electronic communication is established through Telnet protocol.

In yet another embodiment the remote client is web browsing software.

In another embodiment, the electronic communication is established through hypertext transfer protocol.

In an embodiment, the electronic device screen is a touch screen.

In another embodiment, the predefined keypad is stored on a memory in the electronic device or in a memory in the host computer.

In an embodiment, the set of keys of the predefined keypad includes a limited set of keys selected from the group consisting of numeric keys, functions keys and alphanumeric keys.

### DESCRIPTION OF THE DRAWINGS

The invention will now be described by way of example, with reference to the accompanying Figures, of which:

FIG. 1 is a perspective view of a user wearing an electronic device;

FIG. 2 is a perspective environmental view of a user with the electronic device;

FIG. 3 is a block diagram of the electronic device and host computer in an electronic communication;

FIG. 4 is a flow chart of a method of controlling the formatting of a screen of the electronic device;

FIG. 5 is a flow chart of a method of controlling the formatting of a screen of the electronic device;

FIG. 6 is a plan view of a touch screen of the electronic device with a host controlled pop-up keypad having a subset of function keys;

FIG. 7 is a plan view of a touch screen of the electronic device with a host controlled pop-up keypad having another subset of function keys;

FIG. 8 is a plan view of a touch screen of the electronic device with a host controlled pop-up keypad having a subset of function and numeric keys; and

FIG. 9 is a plan view of a touch screen of the electronic device with a hot controlled pop-up keypad having a subset of numeric keys.

### DETAILED DESCRIPTION

Generally, a method of controlling the formatting of a small screen display of an electronic device in communication with a host computer in a networked computer environment is disclosed. The method includes establishing an electronic communication between a remote client on an electronic device and a host computer. The host computer includes a plurality of host display screens, which are captured. Each captured host display screen is assigned an identification code. A small screen device layout is defined for each captured host display screen. The small screen device layouts are sized for the smaller screen of the electronic device. The small screen device layout is then stored locally on the electronic device. When the electronic device establishes a subsequent electronic communication with the host computer, the appropriate small screen device layouts are displayed instead of the corresponding larger host display screen from the host computer by detecting the identification code assigned thereto.

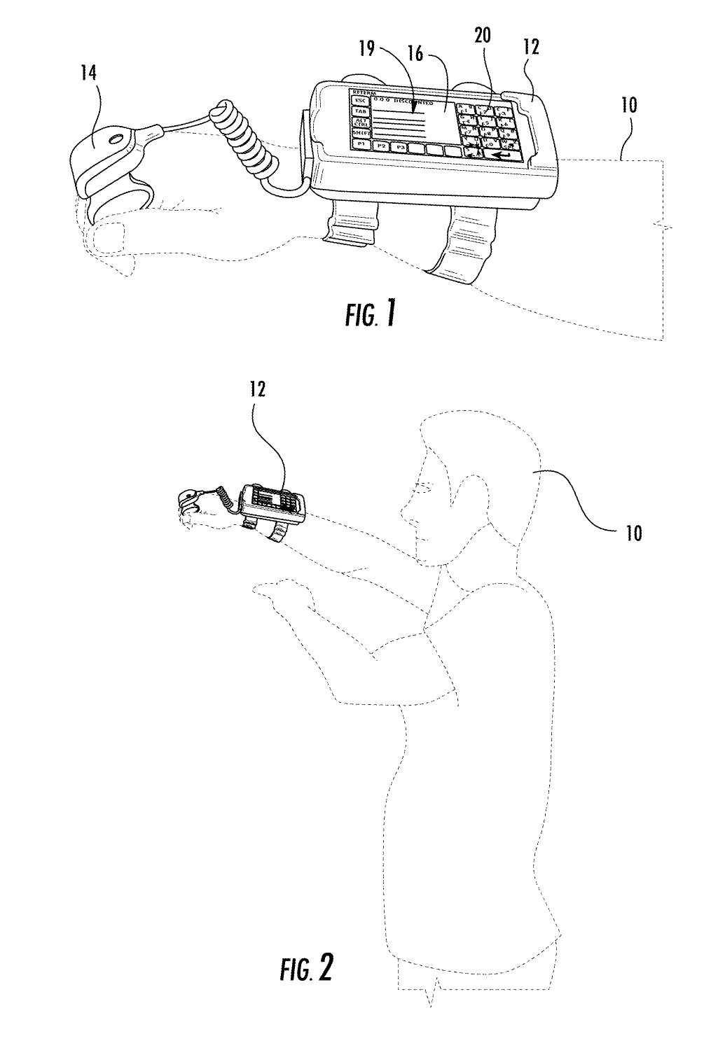

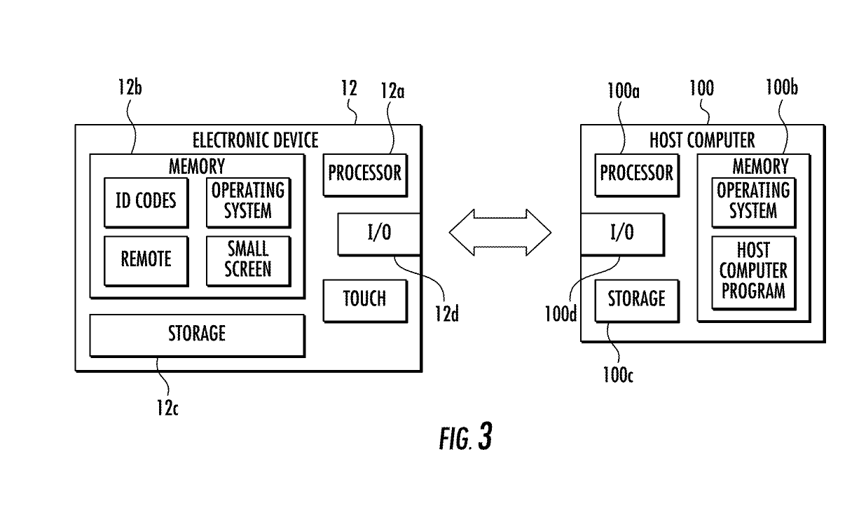

In the embodiments shown in FIGS. 1-3, a user 10 is wearing a portable electronic device 12. In addition to a barcode scanner 14, shown for example on the user's finger, the portable electronic device 12 includes a touch screen user interface (or “touch screen”) 16 for input. The portable electronic device 12 also generally includes a processor 12a, memory 12b, storage 12c (such as flash memory), and input/output controller 12d (such as wireless radios). An operating system software runs in the memory of the device 12 and may be stored in the memory 12b or optionally embedded in, for example, a ROM. A remote client runs in the memory 12b and is configured to establish communication with, and then interact with, the host computer 100. These portable electronic devices 12 are often used in inventory and logistics control in warehouses or depots and other industries where a large number of items must be tracked; however, these devices 12 have many other uses and the disclosure herein is not limited to the same, but merely provided for context. The exemplary embodiment may be used in any electronic device 12 having a touch screen 16 that communicates with a host computer 100 via a remote client. The exemplary embodiment permits the electronic device 12 to display appropriately sized screens with pop-up keypads 20 on the smaller screen 16 of the electronic device 12 without modification to the host computer program.

As shown in for example in FIG. 3, the host computer 100 also includes a processor 100a, memory 100b, storage 100c, and input/output controller 100d (which may be wireless). An operating system runs in the memory 100b of the host computer 100. The host computer 100 further includes a host computer program, which the user operating a portable electronic device 12 may need access to from time to time as the case may be. However the host computer program includes host display screens intended for larger displays and which are designed for true keypad input.

Because these devices 12 lack true keypads with physical keys, the user enters data with a pop-up software keypad. Popup keypads are advantageous in that they can be customized to the data being entered. If an application has been written to run locally on the device, it can pop up the required keypads as appropriate and display the appropriate set of keys. If however, the device 12 is running a terminal emulator or a browser (rather than a specific local application), this type of automatic control of the popup keypads is not possible. These implementations rely on the user to manually call up the keypads as needed.

In an embodiment shown in FIG. 3, a method provides a customized remote client software for establishing an electronic communication with a host computer 100. This customized remote client permits the electronic device 12 to display an appropriately sized small screen device layout of the host display screen as sent by the host computer 100 and further allows the electronic device 12 to automatically invoke a predetermined popup keypad on the electronic device 12. The remote client could be a Telnet/ANSI terminal emulation program for establishing a telnet protocol communication with the host computer 100 or web browsing software for establishing a hypertext transfer protocol communication with a host computer 100. Other remote clients implementing other communication protocols may be used as well. In either case, the remote client includes commands that allow the electronic device 12 to display a small screen device layout with pop up keypads on the electronic device. This enables the larger host display screens of the host computer program (intended for full screen desktop personal computers) to be more appropriately displayed on electronic devices 12 with smaller screens.

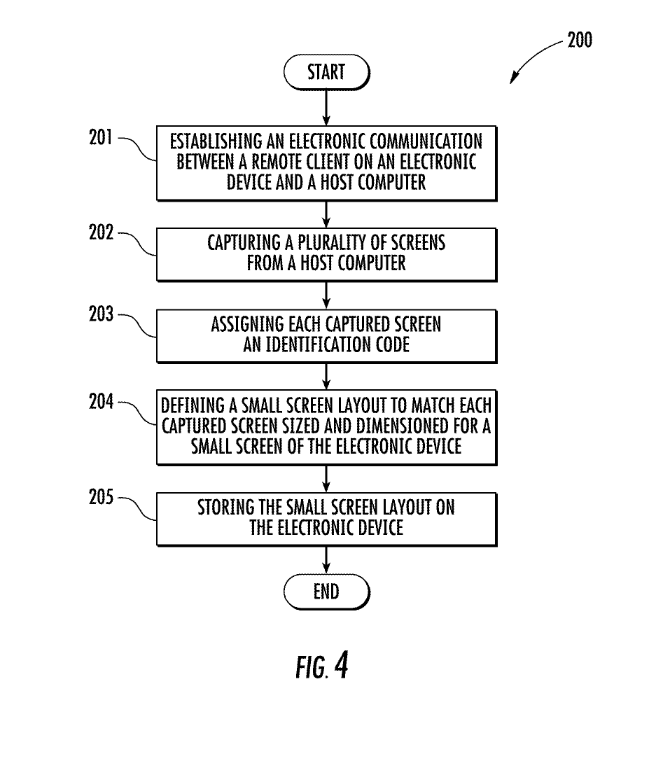

In an embodiment shown in FIG. 4, a method 200 is disclosed for the electronic device 12 establishing electronic communication with the host computer 100 and the host computer 100 invoking a pop-up soft keypad on the electronic device 12. Electronic communication between the remote client on the electronic device 12 and the host computer 100 is established at block 201. The host display screens of the host computer program are captured at block 202, assigned an identification code (or ID) at block 203, and a small screen device layout is defined to match each host display screen at block 204. The small screen device layout is stored in the memory 12b of the electronic device 12 at block 205. Whenever the ID of a host display screen is detected by the remote client, the small screen device layout is displayed instead. This capability can also be used to call up an appropriate keypad. Whenever a screen call comes from the host, its ID can be recognized by the remote client and the appropriate small screen device layout and keypad can be displayed on the screen of the electronic device. The user makes the associations between the host display screens and the small screen device layouts one time on the electronic device 12. The host computer program on the host computer does not have to be rewritten or modified. Furthermore existing applications written for electronic devices 12 that expect a true, physical keypad may be run on a keyless device, such as a device with a touch screen. It is important to note that no host modifications are required, and the appropriate keypad (number, size, and exact layout of keys) can be called up for the user for each data entry screen of the host computer program.

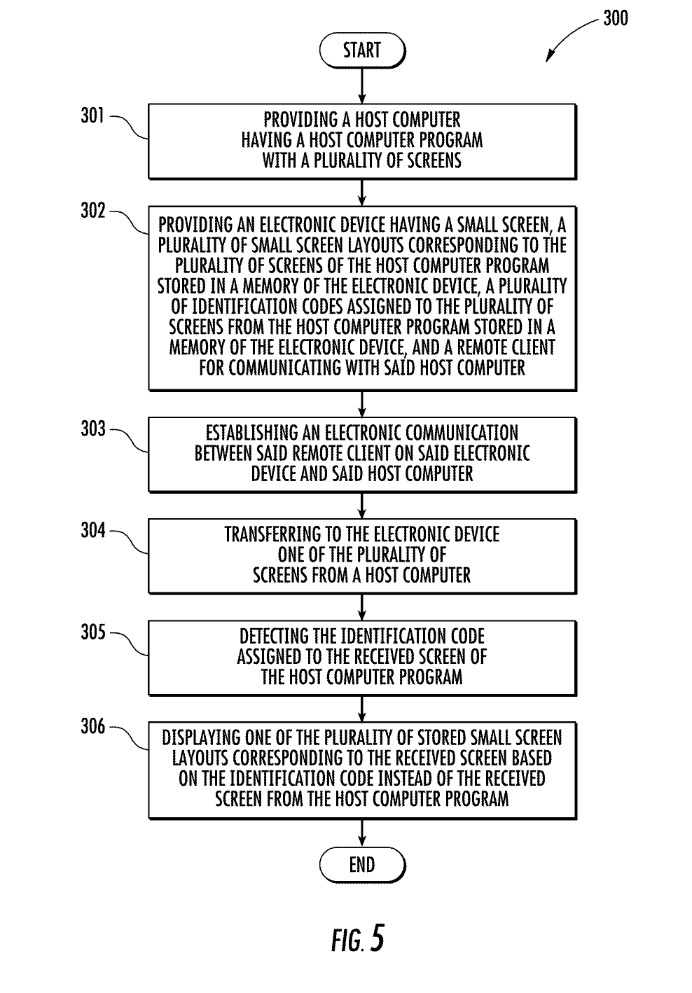

In an embodiment shown in FIG. 5, a method 300 is disclosed for providing an electronic device 12 and host computer 100 configured to establish an electronic communication where the host computer 100 is configured to invoke a pop-up soft keypad on the electronic device 12. The host computer 100 is provided with a host computer program with a plurality of screens at block 301. The electronic device 12 is provided with a small display screen, a plurality of small screen layouts corresponding to the plurality of screens of the host computer program stored in the memory 12b of the electronic device 12, a plurality of identification codes assigned to the plurality of screens from the host computer program stored in the memory 12b of the electronic device 12, and a remote client for communication with the host computer 100 at block 302. Electronic communication between the remote client on the electronic device 12 and the host computer 100 is established at block 303.

Although the remote client is described as software in the above embodiments, in other embodiments, the remote client is firmware embedded in the electronic device 12. The methods 200,300 described herein may further be encoded in any program language and configured to run on any operating system.

These small screen device layouts and keypads are fully customizable for the input needed (or allowed) by the host computer 100. For example, in an embodiment shown in FIG. 6, a small screen device layout 50a includes a pop-up soft keypad 20 having a first portion 20a, second portion 20b, and third portion 20c is shown on the remote client 22. The small screen device layout 50a includes a viewing area 19 of the host display screen sent from the host computer program. The viewing area 19 is sized for the smaller screen of the electronic device 12. The keypad 20 includes a set of function keys (e.g. F1-F10, left cursor, right cursor, space and enter) in the first portion 20a displayed in the grid pattern on the right side of the touch screen 16. Special operations keys, such as escape (ESC), tab, alt, and shift may be displayed in the second portion 20b to the left side of the touch screen 16. Additional function keys such as P1, P2, P3 and color coded keys, such as a green key, orange key and blue key may also be included in the third portion 20c that have tailored input for the host computer 100.

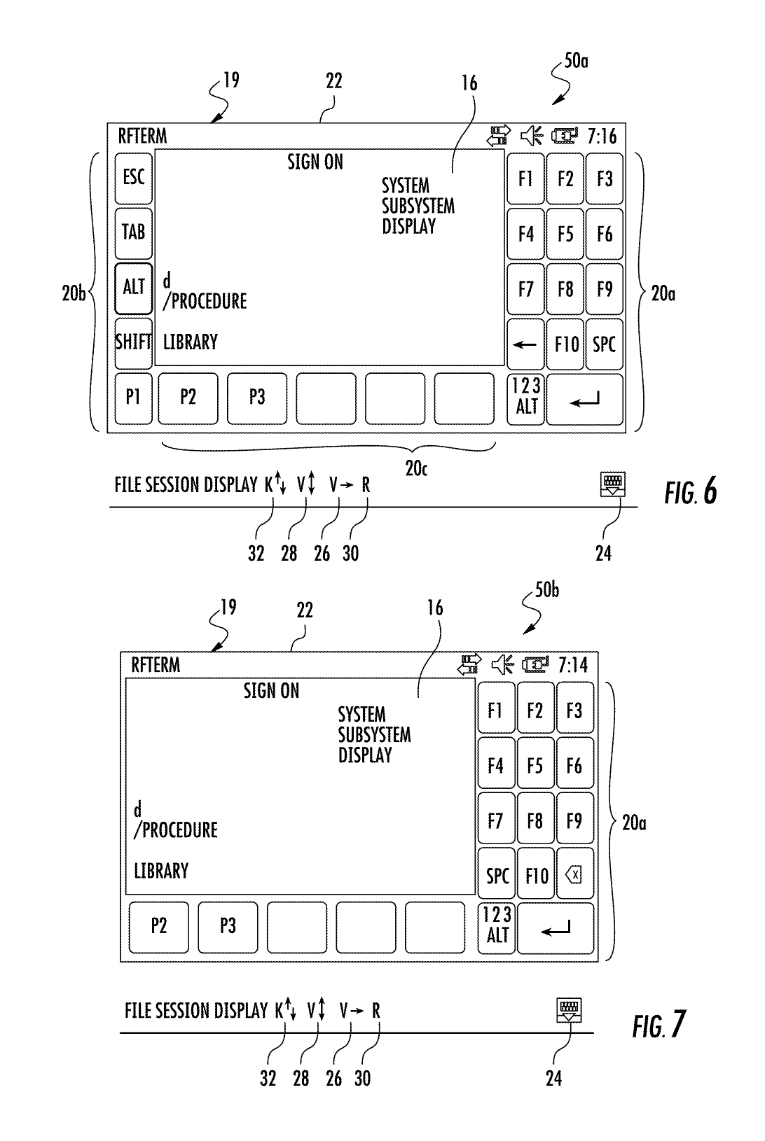

In an embodiment shown in FIG. 7, a small screen device layout 50b has a pop-up keypad 20 in a first portion 20a. The small screen device layout 50b includes a formatted area of the screen received from the host computer program where the small screen device layout 50b is sized for the small screen. The keypad may include a set of function keys (F1-F10, left cursor, right cursor, space and enter) in the first portion 20a displayed in the grid pattern on the right side of the touch screen, which is advantageously sized for the smaller device touch screen.

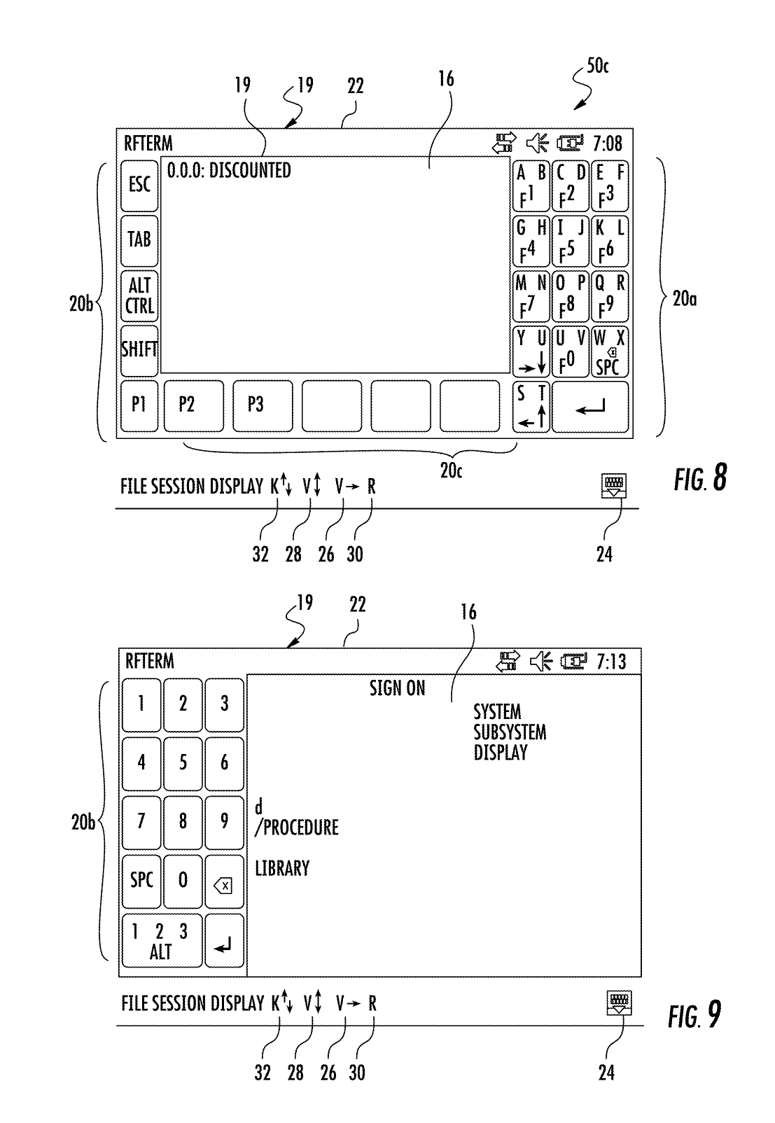

In an embodiment shown in FIG. 8, a small screen device layout 50c has a pop-up keypad 20. The small screen device layout 50c includes a formatted area which is sized for the smaller device screen. The keypad 20 includes a set of numeric keys (1-10, left cursor, right cursor, space and enter) in the first portion 20a displayed in the grid pattern on the right side of the touch screen. Further the numeric keypad may further include additional indicia indicating alternate input from key combinations, such as shift and alt, for example. Special operations keys, such as escape (ESC), tab, control (CTRL), and shift may be displayed in the second portion 20b to the left side of the touch screen 16. Additional function keys such as P1, P2, P3 and color coded keys, such as a green key, orange key and blue key may also be included in a third portion 20c at a bottom side of the touch screen 16 that have tailored input for the host computer 100.

In an embodiment shown in FIG. 9, a small screen layout 50d having a pop-up keypad 20. The small screen layout includes a formatted screen area that is sized for the small screen. The keypad 20 includes a set of numeric keys (1-10, space (spc), delete, alt and enter) in the first portion 20a displayed in the grid pattern on the left side of the touch screen 16.

Those of ordinary skill in the art would appreciate that the exemplary small screen device layouts 50a-d and keypads 20, shown in the embodiments of FIGS. 6-9 and described above may include other layouts, and keys as needed by the host computer program. The keypad layout and arrangement 20 can be customized. The user may store a preference for having a numeric keypad, for example, to appear in various portions 20a, 20b, 20c of the touch screen as desired. The user may prefer some function keys to appear at a top side of the touch screen 16 versus the bottom side in yet a fourth portion. Further, the size and dimensions of the keys may be fixed or dynamic, automatically sizing the width and height of the keys to show more of the remote client 22, or less, as desired, and such control may also be based on the dimensions of the touch screen 16.

The various portions 20a, 20b, 20c of the keypad 20 may be selectively hidden and rotated by the user as well to allow more of the touch screen 16 to be seen by the user, or to position the screen optimally for the user if the user is left handed versus right handed. In particular, use of a “select” key 26 permits the user to select a desired portion 20a, 20b, 20c of the keypad 20 and then hide it via a view key 28, or rotate it via a rotate key 30.

Although the small screen and keypads are invoked automatically by the remote client 22, the user nevertheless may override the remote client and invoke a full alphanumeric keypad via a keyboard icon 24. The user may further access additional functions of the electronic device 12 by selecting a menu key 32 without exiting or otherwise disturbing the remote client 22 and keypad 20.

For these reasons, the method of controlling the formatting of a screen of an electronic device 12 having a small screen in communication with a host computer 100 in a networked computer environment is believed to represent significant advancements in the art, which have substantial commercial merit.

In particular, the ability of the electronic device 12 to automatically display smaller screen layouts and invoke keypads having discrete set of keys related to the input needed, permits the user to focus on the task rather than operation of the electronic device 12. Further, the small dimensions of the touch screen are used more efficiently as it permits more screen to be used for the task.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

While there is shown and described herein certain specific structures embodying the invention, it will be manifest to those skilled in the art that various modifications and rearrangements of the parts may be made without departing from the spirit and scope of the underlying concept, and that the invention is not limited to the particular forms herein shown and described except insofar as indicated by the scope of the appended claim.

What is claimed is:

1. A method of controlling the formatting of a screen of an electronic device in communication with a host computer in a networked computer environment, comprising the steps of:
establishing an electronic communication between a remote client on an electronic device and a host computer;
capturing a plurality of host display screens from a host computer;
assigning each captured host display screen an identification code;
defining a small screen device layout to match each captured host display screen, wherein the device layout is sized for the screen of the electronic device;
loading the small screen device layout on the small screen of the electronic device; and
loading a predefined keypad sized for the small screen of the electronic device;
whereby when the electronic device establishes a subsequent electronic communication with the host computer, the appropriate small screen device layout is displayed instead of the corresponding host display screen from the host computer by detecting the identification code assigned thereto.

2. The method of claim 1, wherein the electronic device is a portable data terminal.

3. The method of claim 1, wherein the remote client is terminal emulation software.

4. The method of claim 3, wherein the electronic communication is established through Telnet protocol.

5. The method of claim 1, wherein the remote client is web browsing software.

6. The method of claim 5, wherein the electronic communication is established through hypertext transfer protocol.

7. The method of claim 1, wherein the small screen is a small touch screen.

8. The method of claim 1, wherein the predefined keypad is stored on a memory in the electronic device or in a memory in the host computer.

9. The method of claim 1, wherein the set of keys of the predefined keypad includes numeric keys only.

10. The method of claim 1, wherein the set of keys of the predefined keyboard includes all alphanumeric keys.

11. The method of claim 1, wherein the set of keys of the predefined keyboard includes function keys.

12. A method of controlling a soft keypad in a networked computer environment, comprising the steps of:
providing a host computer having a host computer program with a plurality of host display screens;
providing an electronic device having
a small screen,
a plurality of small screen device layouts each corresponding to the plurality of host display screens of the host computer program stored in a memory of the electronic device,
a plurality of identification codes assigned to the plurality of host display screens from the host computer program stored in a memory of the electronic device, and
a remote client for communicating with said host computer;
establishing an electronic communication between said remote client on said electronic device and said host computer, the electronic communication requiring keypad input;
receiving one of the plurality of host display screens from a host computer program;
detecting the identification code assigned to the received host display screen of the host computer program;
displaying one of the plurality of stored small screen device layouts corresponding to the received host display screen based on the identification code instead of the received host display screen from the host computer program; and
displaying a predefined keypad sized on the small screen that corresponds to the detected identification code.

13. The method of claim 12, wherein the electronic device is a portable data terminal.

14. The method of claim 12, wherein the remote client is terminal emulation software.

15. The method of claim 14, wherein the electronic communication is established through Telnet protocol.

16. The method of claim 12, wherein the remote client is web browsing software.

17. The method of claim 16, wherein the electronic communication is established through hypertext transfer protocol.

18. The method of claim 12, wherein the electronic device screen is a touch screen.

19. The method of claim 12, wherein the predefined keypad is stored on a memory in the electronic device or in a memory in the host computer.

20. The method of claim 12, wherein the set of keys of the predefined keypad includes a limited set of keys selected from the group consisting of numeric keys, functions keys and alphanumeric keys.
